(19) United States
(12) Patent Application Publication
(10) Pub. No.: US 2013/0048751 A1
(43) Pub. Date: Feb. 28, 2013

(54) METHOD AND DEVICE FOR OPERATING AN INJECTION VALVE

(71) Applicants: Vincent Dian, Oberstimm (DE); Christian Stahl, Obertraubling (DE)

(72) Inventors: Vincent Dian, Oberstimm (DE); Christian Stahl, Obertraubling (DE)

(21) Appl. No.: 13/639,236

(22) PCT Filed: Apr. 6, 2011
(86) PCT No.: PCT/EP2011/055303

§ 371 Date: Oct. 10, 2012

(30) Foreign Application Priority Data
Apr. 8, 2010 (DE) 10 2010 014 208.5

(51) Int. Cl. F02M 47/02; F02M 59/46; F02D 41/30

(52) U.S. Cl. 239/91; 239/533.4; 701/104

(57) ABSTRACT

An injection valve includes a nozzle needle that suppresses a metered addition of fluid in a closed position and otherwise allows the metered addition of fluid. The valve includes a control chamber hydraulically coupled to the nozzle needle such that the fluid pressure of the chamber influences the nozzle needle position. The pressure of the chamber can be influenced by a control valve having a control valve body. The injection valve includes a solid state actuator that acts on the control valve body. To perform a closing operation of the nozzle needle, the control valve body is controlled to the closed position by partially discharging the solid state actuator to a predetermined partial charge such that the actuator remains force-coupled to the control valve body even after the closed position of the control valve body has been reached. The actuator is used as a pressure sensor during the closing operation.

### CROSS-REFERENCE TO RELATED APPLICATIONS

This application is a U.S. National Stage Application of International Application No. PCT/EP2011/055303 filed Apr. 6, 2011, which designates the United States of America, and claims priority to DE Application No. 10 2010 014 208.5 filed Apr. 8, 2010, the contents of which are hereby incorporated by reference in their entirety.

### TECHNICAL FIELD

This disclosure relates to a method and a device for operating an injection valve which is used in particular for dosing fluid, specifically in particular fuel.

### BACKGROUND

Ever more stringent legal regulations regarding the admissible pollutant emissions of internal combustion engines that are used in motor vehicles make it necessary to implement various measures by which the pollutant emissions can be lowered. One approach here is to lower the pollutant emissions generated during the combustion process of the air/fuel mixture. In this context, extremely precise dosing of fuel is advantageous.

DE 102005024194 A1 discloses an injection valve for dosing fuel, which injection valve comprises a body with a high-pressure supply, an actuating drive which acts on a switching valve, a control chamber which communicates with the high-pressure supply and whose control chamber pressure is dependent on the position of the switching valve. The injection valve also comprises a nozzle needle whose position is dependent on the control chamber pressure. A pressure sensor device is arranged in the high-pressure supply in such a way that the pressure sensor device can detect the pressure of the fluid in the high-pressure supply.

DE 10024662 B4 discloses a method for operating an injection valve having a piezoelectric actuator which is controlled by a control circuit. The injection valve has a nozzle needle which, as a function of the pressure in a control chamber, can be moved into various positions in which different injection states of the injection valve can be set. The pressure in the control chamber can be influenced by the piezoelectric actuator via a valve member which is connected to the piezoelectric actuator. The valve member is formed simultaneously as a stop element for the nozzle needle. For the activation of the piezoelectric actuator, the piezoelectric actuator is supplied with a predefined charge by the control circuit via two terminals. The voltage at the terminals is detected, and the pressure in the control chamber is determined from the voltage. The control circuit controls the piezoelectric actuator as a function of the pressure in the control chamber.

DE 10162250 A1 discloses a fuel injection valve for the direct injection of fuel into a combustion chamber of an internal combustion engine, having a piezoelectric or magnetostrictive actuator and having a valve closing body which can be actuated by the actuator and which interacts with a valve seat surface to form a sealing seat. The actuator is constructed from an opening actuator, a compensation actuator and a measurement element. In an actuation path between the actuator and the valve closing body there is provided a compensation gap. The measurement element measures the forces exerted on the valve closing body by the actuator. The actuator is regulated such that the compensation gap is kept closed. The valve closing body is part of a valve needle, with fuel being dosed or not being dosed by means of the fuel injection valve as a function of the position of said valve needle. The actuator thus acts directly on the valve needle.

### SUMMARY

In one embodiment, a method is provided for operating an injection valve having a nozzle needle which prevents a dosing of fluid when in a closed position and otherwise permits the dosing of fluid, having a control chamber which is hydraulically coupled to the nozzle needle in such a way that the fluid pressure of said control chamber influences the position of the nozzle needle, and the pressure of which control chamber can be influenced by means of a switching valve which has a switching valve body, and having a solid body actuator which is designed to act on the switching valve body, wherein to execute a closing process of the nozzle needle, the switching valve body is controlled so as to move into its closed position by means of a partial discharge of the solid body actuator to a predefined partial charge in such a way that, even after the closed position of the switching valve body is reached, the solid body actuator is still coupled in terms of force to the switching valve body, and the solid body actuator is used as a pressure sensor during the execution of the closing process of the nozzle needle.

In a further embodiment, the predefined partial charge is determined in an operating state of the injection valve in which the nozzle needle is situated in its closed position, specifically through variation of the partial charge and as a function of a measurement signal of a pressure sensor which detects a fluid pressure in a fluid supply which is hydraulically coupled to the injection valve.

In another embodiment, a device is provided for operating an injection valve having a nozzle needle which prevents a dosing of fluid when in a closed position and otherwise permits the dosing of fluid, having a control chamber which is hydraulically coupled to the nozzle needle in such a way that the fluid pressure of said control chamber influences the position of the nozzle needle, and the pressure of which control chamber can be influenced by means of a switching valve which has a switching valve body, and having a solid body actuator which is designed to act on the switching valve body, wherein the device is designed such that, to execute a closing process of the nozzle needle, the switching valve body is controlled so as to move into its closed position by means of a partial discharge of the solid body actuator to a predefined partial charge in such a way that, even after the closed position of the switching valve body is reached, the solid body actuator is still coupled in terms of force to the switching valve body, and the solid body actuator is used as a pressure sensor during the execution of the closing process of the nozzle needle.

### BRIEF DESCRIPTION OF THE DRAWINGS

Example embodiments will be explained in more detail below with reference to figures, in which:

FIG. 1 shows an injection valve having a control device, and

FIG. 2 shows a flow diagram of a program which is executed in the control device.

### DETAILED DESCRIPTION

Some embodiments provide a method and a device for operating an injection valve, which method and device permit a precise dosing of fluid by the injection valve.

For example, embodiments provide a method and a device for operating an injection valve having a nozzle needle which prevents a dosing of fluid when in a closed position and otherwise permits the dosing of fluid.

The injection valve may include a control chamber which is hydraulically coupled to the nozzle needle in such a way that the fluid pressure of said control chamber influences the position of the nozzle needle, and the pressure of which control chamber can be influenced by means of a switching valve which has a switching valve body. The injection valve furthermore has a solid body actuator which is designed to act on the switching valve body. To execute a closing process of the nozzle needle, the switching valve body is controlled so as to move into its closed position by means of a partial discharge of the solid body actuator to a predefined partial charge in such a way that, even after the closed position of the switching valve body is reached, the solid body actuator is still coupled in terms of force to the switching valve body, and the solid body actuator is used as a pressure sensor during the execution of the closing process of the nozzle needle.

In this way, it may be possible for example to very precisely detect the pressure profile during the closing process, and in particular also to precisely detect the closed position of the nozzle needle being reached.

In one embodiment, the predefined partial charge is determined in an operating state of the injection valve in which the nozzle needle is situated in its closed position, specifically through variation of the partial charge and as a function of a measurement signal of a pressure sensor which detects a fluid pressure in a fluid supply which is hydraulically coupled to the injection valve. In this way, the partial charge can be predefined particularly precisely, specifically also as a function of the respective individual injection valve and the individual characteristics thereof.

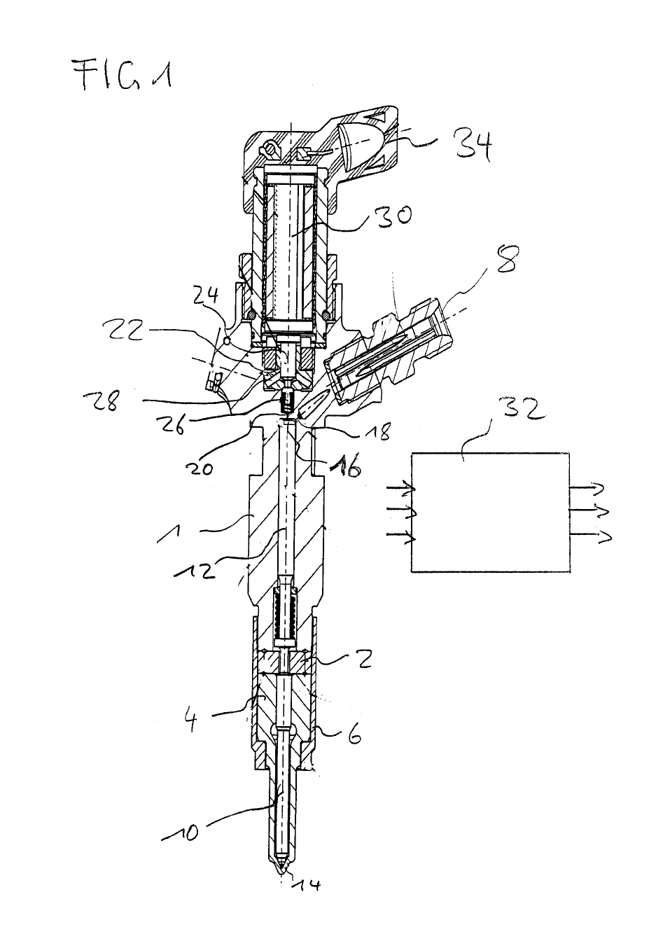

As shown in FIG. 1, an injection valve has an injector housing 1 which is furthermore assigned an adapter plate 2, a nozzle body 4 and a nozzle clamping nut 6. The nozzle clamping nut 6 couples the adapter plate 2 and the nozzle body 4 to the injector housing 1. It is basically also possible for the adapter plate 2 and/or the nozzle body 4 to be formed in one piece with the injector housing 1.

The injector housing 1 furthermore has a fluid inlet 8 which is hydraulically coupled to a fluid supply which comprises for example a high-pressure fluid accumulator. In the high-pressure fluid accumulator there may be arranged for example a pressure sensor which can detect the pressure in the fluid supply.

In a recess of the injector body 1, which recess may also extend through the adapter plate 2 and is also formed on the nozzle body 4, there is arranged a nozzle needle 10 which may comprise a control piston 12. The nozzle needle 10 may be of single-part or else multi-part form and thus comprise for example the control piston 12 as a separate part.

In the nozzle body 4 there is formed at least one injection hole 14 which extends out of the nozzle body 4 to the outside proceeding from the recess.

When the nozzle needle 10 is in a closed position, it prevents a dosing of fluid through the at least one injection hole 14. When the nozzle is outside the closed position, that is to say when the nozzle needle is situated in the axial direction along the longitudinal axis of the injection valve in a position shifted upward in the plane of the drawing in relation to its closed position, said nozzle needle permits the dosing of fluid.

At an axial end of the control piston 12 remote from the injection hole 14, a control chamber 16 is formed in the recess. The control chamber 16 communicates via an inflow throttle 18 with the fluid inlet 8. Furthermore, the control chamber 16 is assigned an outflow throttle 20, wherein downstream of the outflow throttle 20 there is arranged a switching valve 22, as a function of the switching position of which hydraulic coupling to a low-pressure chamber 28 can be set.

The switching valve 22 comprises a switching valve body. The switching valve body may have a valve piston 24 which acts on a valve head 26. The valve head 26 is preloaded into a closed position by means of a switching valve spring and is or is not moved out of said closed position as a function of the forces introduced via the valve piston 24.

Also provided is a solid body actuator 30 which acts on the switching valve body. The solid body actuator 30 is formed for example as a piezoelectric actuator or as some other solid body actuator known to a person skilled in the relevant art for such purposes.

Also provided is a control device 32 which may also be referred to as a device for operating the injection valve and which generates actuating signals, in particular for the injection valve, as a function of at least one measurement signal of at least one sensor. For the electrical coupling of the control device 32 to the injection valve, said injection valve has an electrical terminal 34.

When electrical energy and thus in particular charge is supplied to the solid body actuator 30, the latter extends and in particular firstly overcomes an idle travel between the solid body actuator 30 and the switching valve body and then, with increasing charge supplied, exerts an increasing force on the switching valve body, such that the valve head 26 then moves out of its closed position and fluid can thus flow out of the control chamber 16 via the outflow throttle 18 to the low-pressure chamber 28 and the pressure in the control chamber 18 thus falls. In this context, it is pointed out that, by means of suitable dimensioning of the inflow throttle 18 and of the outflow throttle, a desired pressure drop can be effected when the switching valve 22 is open.

With falling pressure in the control chamber 16, the resultant force acting on the nozzle needle 10 ultimately changes such that the nozzle needle 10 moves out of its closed position and thus permits the supply of fluid through the at least one injection hole 14.

When charge is subsequently withdrawn again from the solid body actuator 13, the valve head 26 moves back into its closed position again, and the pressure in the control chamber 16 rises again, specifically until the resultant force on the nozzle needle 10 causes the nozzle needle 10 to move back into its closed position.

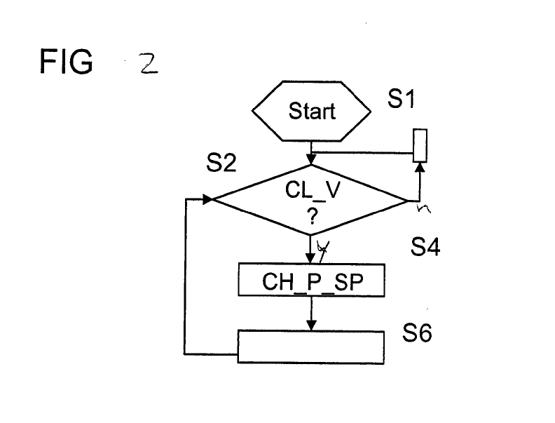

In the control device 32 there is stored a program which is executed during the operation of the injection valve. The program is started in a step S1 (FIG. 2) in which, if appropriate, variables are initialized. In step S2, it is checked whether a closing process CL_V of the nozzle needle 10 should be executed. If this is not the case, the process is continued from step S2 again, if appropriate after a predefined waiting time.

By contrast, if the condition of step S2 is met, the closing process CL_V of the nozzle needle is executed in step S4. For this purpose, the switching valve body is controlled so as to move into its closed position by means of a partial discharge of the solid body actuator 30 to a predefined partial charge CH_P_SP in such a way that, even after the closed position of the switching valve body is reached, the solid body actuator 30 is still coupled in terms of force to the switching valve body. A situation is thus prevented in which an idle travel forms between the solid body actuator 30 and the switching valve body during the execution of the closing process of the nozzle needle.

In a step S6, during the execution of the closing process of the nozzle needle 10, the solid body actuator 30 is then used as a pressure sensor. In this way, it is then possible, even after the closed position of the switching valve body, that is to say in particular of the valve head 26, is reached, to still detect the pressure which is representative of the pressure in the control chamber 16, and thus inter alia precisely detect the closed position of the nozzle needle being reached. For example, following the detection of the closed position of the nozzle needle 10 being reached, it is then also possible for the solid body actuator 30 to be discharged further, such that the partial charge is also discharged. This however need not imperatively be provided.

The predefined partial charge CH_P_SP may for example be determined in an operating state of the injection valve in which the nozzle needle 10 is situated in its closed position, specifically through variation of the partial charge CH_P_SP and as a function of a measurement signal of a pressure sensor which detects a fluid pressure in the fluid supply. In this way, it is possible to implement a so-called idle travel compensation function which can identify an onset of switching leakage at the switching valve 22 by means of the pressure sensor and thus precisely determine the required partial charge CH_P_SP at which it is ensured that force coupling exists between the solid body actuator 30 and the switching valve body and on the other hand there is no outflow of fluid from the control chamber 16 to the low-pressure chamber 28, that is to say the switching valve body is in its closed position.

The predefined partial charge CH_P_SP may for example be predefined such that, when the predefined partial charge is present, there is a potential difference of approximately 30 V across the solid body actuator 30. When the solid body actuator 30 is fully charged, a potential difference of approximately 130 V is for example present.

What is claimed is:

1. A method for operating an injection valve having a nozzle needle that prevents a dosing of fluid when in a closed position and otherwise permits the dosing of fluid, and a control chamber hydraulically coupled to the nozzle needle in such a way that the fluid pressure of said control chamber influences the position of the nozzle needle, the method comprising:
influencing the pressure of the injection valve control chamber using a switching valve having a switching valve body, and
executing a closing process of the nozzle needle by implementing a partial discharge of a solid body actuator to a predefined partial charge, the partial discharge of the solid body actuator to the predefined partial charge moving the switching valve body to its closed position in such a way that, even after the closed position of the switching valve body is reached, the solid body actuator remains force-coupled to the switching valve body, and
using the solid body actuator as a pressure sensor during the execution of the closing process of the nozzle needle.

2. The method of claim 1, further comprising determining the predefined partial charge during an operating state of the injection valve in which the nozzle needle is situated in its closed position.

3. A device for operating an injection valve having a nozzle needle that prevents a dosing of fluid when in a closed position and otherwise permits the dosing of fluid, having a control chamber which is hydraulically coupled to the nozzle needle in such a way that the fluid pressure of said control chamber influences the position of the nozzle needle, the device comprising:
a switching valve configured to influence the pressure of the injection valve control chamber, the switching valve comprising:
a switching valve body, and
a solid body actuator which is designed to act on the switching valve body,
wherein the device is configured to execute a closing process of the nozzle needle by implementing a partial discharge of the solid body actuator to a predefined partial charge, the partial discharge of the solid body actuator to the predefined partial charge moving the switching valve body to its closed position in such a way that, even after the closed position of the switching valve body is reached, the solid body actuator remains force-coupled to the switching valve body, and
wherein the solid, body actuator is configured for use as a pressure sensor during the execution of the closing process of the nozzle needle.

4. The device of claim 3, wherein the device is further configured to determine the predefined partial charge during an operating state of the injection valve in which the nozzle needle is situated in its closed position.

5. The device of claim 3, wherein the device is further configured to determine the predefined partial charge by variation of a partial charge and as a function of a measurement signal of a pressure sensor that detects a fluid pressure in a fluid supply that is hydraulically coupled to the injection valve.

6. The method of claim 1, further comprising determining the predefined partial charge by variation of a partial charge and as a function of a measurement signal of a pressure sensor that detects a fluid pressure in a fluid supply that is hydraulically coupled to the injection valve.

7. An injection valve system, comprising:
an injection valve comprising:
a nozzle needle that prevents a dosing of fluid when in a closed position and otherwise permits the dosing of fluid, and
a control chamber which is hydraulically coupled to the nozzle needle in such a way that the fluid pressure of said control chamber influences the position of the nozzle needle, and
a control system for operating the injection valve, the control system comprising:
a switching valve configured to influence the pressure of the injection valve control chamber, the switching valve comprising:
a switching valve body, and
a solid body actuator which is designed to act on the switching valve body,
wherein the control system is configured to execute a closing process of the nozzle needle by implementing a partial discharge of the solid body actuator to a predefined partial charge, the partial discharge of the solid body actuator to the predefined partial charge moving the switching valve body to its closed position in such a way that, even after the closed position of the switching valve body is reached, the solid body actuator remains force-coupled to the switching valve body, and
wherein the solid body actuator is configured for use as a pressure sensor during the execution of the closing process of the nozzle needle.

8. The injection valve system of claim 7, wherein the control system is further configured to determine the predefined partial charge during an operating state of the injection valve in which the nozzle needle is situated in its closed position.

9. The injection valve system of claim 7, wherein the control system is further configured to determine the predefined partial charge by variation of a partial charge and as a function of a measurement signal of a pressure sensor that detects a fluid pressure in a fluid supply that is hydraulically coupled to the injection valve.
